(19) United States
(12) Patent Application Publication
(10) Pub. No.: US 2011/0317993 A1
(43) Pub. Date: Dec. 29, 2011

(54) Apparatus for Mounting a Webcam to Another Optical Instrument

(75) Inventor: Paul Weissler, Colorado Springs, CO (US)

(73) Assignee: OUTWEST SYSTEMS, INC., Colorado Springs, CO (US)

(21) Appl. No.: 12/822,033

(22) Filed: Jun. 23, 2010

(51) Int. Cl. G03B 17/00

(52) U.S. Cl. 396/428; 396/419

(57) ABSTRACT

The apparatus of the present invention is enables a lens of a camera, preferably a webcam, to be in relational position with an eyepiece of a telescope or a microscope. The apparatus is comprised of two rings, a mounting ring for securing a camera therein and a mounting ring for securing the eyepiece of a scope therein. The camera mounting ring is interrelated with the scope mounting ring by means of at least one strut. At least two locking pins with a cup attached thereto are used to secure the camera within the camera mounting ring and at least two locking pins with a bracket attached thereto are used to secure the scope within the scope mounting ring. The camera mounting ring is slidably related with the strut to permit relational positioning of the camera mounting ring with the scope mounting ring such that the lens of the camera may be abutted with the eyepiece of the scope.

### BACKGROUND OF THE INVENTION

1. Field of the Invention

The field of the present invention relates to an apparatus for mounting a camera, in particular a webcam, to another optical instrument, in particular, such as a telescope or microscope.

2. Description of Related Art Including Information Disclosed Under 37 CFR 1.97 and 37 CFR 1.98

Various apparatuses exist for attaching cameras to telescopes and microscopes. The means by which these apparatuses work vary widely as demonstrated by the following patents.

U.S. Pat. No. 3,399,612 issued 6 Dec. 1965, by Korte for Camera Mount for Optical Instruments discloses an apparatus for mounting a standard still camera to a telescope by means of platform type support.

U.S. Pat. No. 5,053,794 issued 1 Oct. 1991, by Benz for Universal Adapter for Attaching a Camera to Associated Optical Devices Such as Telescopes, Microscopes and the Like discloses an apparatus for mounting a standard still camera to a telescope by means of a universal adapter ring which mates the lens barrel of the camera to the eye lens of the telescope.

U.S. Pat. No. 5,396,487 issued 7 Mar. 1995, by Abe et al. for Structure for Holding an Optical Article discloses a barrel shaped optical holder in which one end attaches to a lens barrel of a camera and the other end attaches to an eye lens of a telescope.

U.S. Pat. No. 7,246,956 issued 24 Jul. 2007, by Pernstich et al. for Apparatus for Fastening a Camera to an Observation Telescope discloses a swivel platform to support a camera in relation to a telescope which platform allows the camera lens to be moved in and out of relational position to the telescope eyepiece.

U.S. Pat. No. 7,575,324 issued 18 Aug. 2009, by Elias et al. for Holding Assembly for a Camera System discloses a platform holding assembly to interconnect a camera with other accessory devices, such as a focus drive, zoom drive, iris drive, lens support or the like.

US Patent Application 2002/0114070 published 22 Aug. 2002, by Barziza for Universal Camera Mounting Adapter and Method discloses a platform type mounting system for mounting a camera for afocal photographic viewing through a telescope eyepiece.

US Patent Application 2002/0197075 published 26 Dec. 2002, by Crockett for Eyepiece to Instrument Coupler discloses a mechanical coupler to convey an optical image from a collector device (telescope) to an image recording device (camera) by means of a platform type support.

US Patent Application 2004/0207750 published 21 Oct. 2004, by Wu et al. for Image Pick-Up Device for Mounting on High Power Monocular (Telescope or Spotting Scope) discloses a digital image device for mounting on a telescope by mating the lens barrel opening of a camera (with the lens barrel removed) directly to the eyepiece of a telescope.

US Patent Application 2008/0152337 published 26 Jun. 2008, by Gartner et al. for Camera Adapter Having a Camera Holder and an Optical Adapter discloses a holder for fixing a camera to an optical observation device (telescope) by means of a platform to support the camera in relational position to the telescope eyepiece with a sleeve to interconnect the lens to the eyepiece.

None of these apparatuses allow for the mounting of a webcam so that a lens of the webcam may be abutted to an eyepiece of a telescope or a microscope.

### BRIEF SUMMARY OF THE INVENTION

The mounting apparatus of the present invention permits a lens of a camera to be abutted to an eyepiece of another optical instrument and comprises at least two mounting rings, interrelated by means of at least one strut; wherein each mounting ring further comprises at least two equidistantly spaced locking pins to mount either a camera or an optical instrument within each of the mounting rings. The strut interrelates with each mounting ring by means of a strut pin. Preferably, the strut slidably interrelates with at least one mounting ring to permit relational positioning of the mounting rings to each other. The locking pins have either a bracket attached thereto to secure the optical instrument within one of the mounting rings, or a cup attached thereto to secure the camera within one of the mounting rings. The mounting apparatus of the present invention may further comprise at least two equidistantly spaced accessory pin through-holes within a mounting ring to permit mounting of an optional accessory device within the mounting ring.

### BRIEF DESCRIPTION OF THE SEVERAL VIEWS OF THE DRAWING(S)

FIG. 1 is a perspective view of the mounting apparatus of the present invention as mounted to a camera and a scope.

FIG. 2 is a perspective view of the mounting apparatus of the present invention.

FIG. 3A is a perspective view of a mounting ring for a camera of the present invention.

FIG. 3B is a perspective view of a mounting ring for a scope of the present invention.

FIG. 4 is a perspective view of a strut of the present invention.

FIG. 5 is a perspective view of a strut pin of the present invention.

FIG. 6 is a perspective view of a locking pin, nut and spring of the present invention.

FIG. 7 is a perspective view of a bracket of the present invention.

FIG. 8 is a cross-sectional view of a bracket of the present invention.

FIG. 9 is a perspective view of a cup of the present invention.

FIG. 10 is cross-sectional view of a cup of the present invention.

### LIST OF REFERENCE NUMERALS

2 mounting apparatus
4 mounting ring (for camera)
6 strut land (on camera mounting ring)
8 strut pin through-holes (in camera mounting ring)
10 locking pin through-holes (in camera mounting ring)
12 accessory pin through-holes (in camera mounting ring)
14 mounting ring (for scope)
16 strut land (on scope mounting ring)
18 strut pin through-holes (in scope mounting ring)
20 locking pin through-holes (in scope mounting ring)
22 accessory pin through-holes (in scope mounting ring)
24 connector strut
26 connector strut first aperture
28 connector strut second aperture
30 strut pin
32 strut knob
34 locking pin
36 head (of locking pin)
38 nut (for locking pin)
40 spring (for locking pin)
42 bracket (for scope)
44 bracket land
46 bracket hole
48 cup (for camera)
50 cup land
52 cup hole
54 camera
56 scope

### DETAILED DESCRIPTION OF THE INVENTION

The apparatus of the present invention allows a lens of a camera to be abutted with an eyepiece of a scope. The scope may be either a telescope or a microscope or other device. The camera may be any type of camera, still or motion, but preferably is a camera that is capable of remote transmission of the pictures it takes. The remote transmission of the pictures allows the pictures to be captured in a database. The camera lens can capture the view visible through the scope eyepiece.

The apparatus of the present invention is enables a webcam to be used in conjunction with a telescope or a microscope. The webcam can capture and record images of objects visible through the telescope or microscope and relay them to a display device, such as a computer monitor.

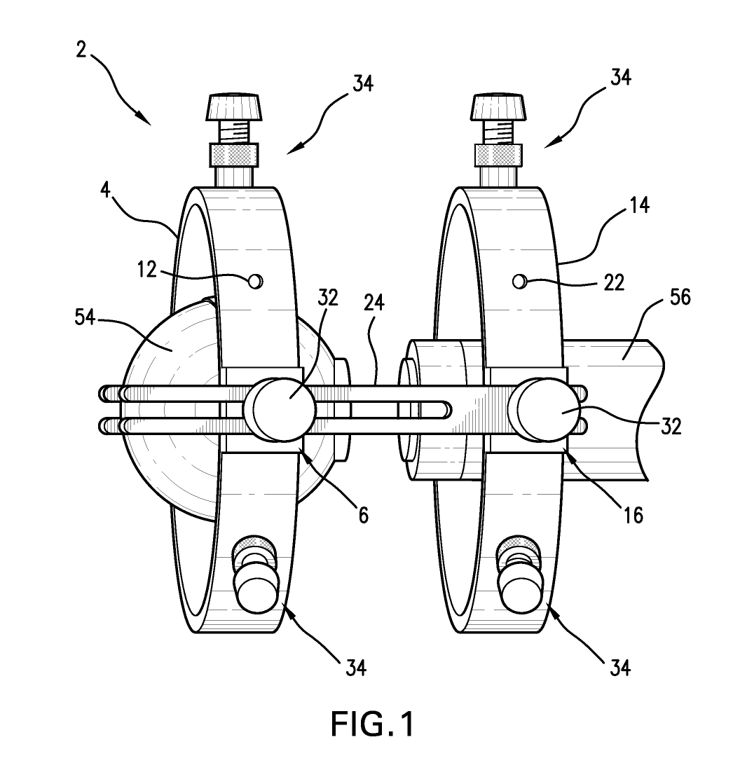

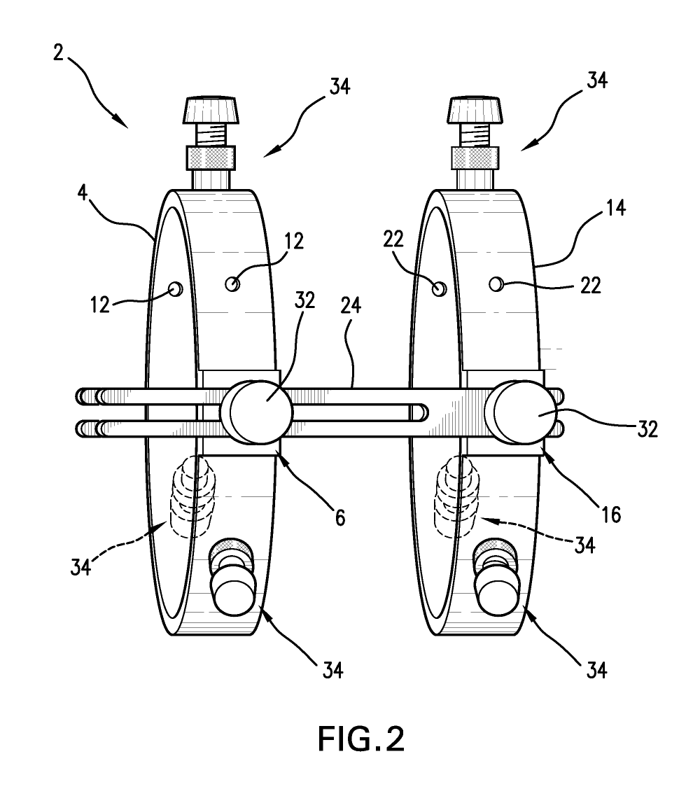

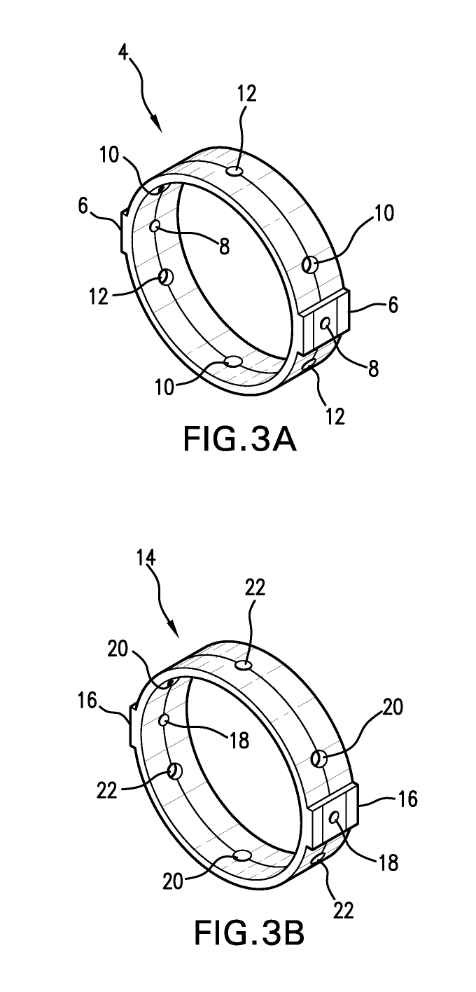

With reference to FIG. 1, FIG. 2, FIG. 3A and FIG. 3B, the apparatus of the present invention 2 is comprised of two rings, a mounting ring for a camera 4 (or camera ring) and a mounting ring for a scope 14 (or scope ring). The mounting rings are the same and are interchangeable as shown in FIG. 3A and FIG. 3B. The camera ring 4 and the scope ring 14 may be any suitable geometric shape, such as a circle, rectangle, square, triangle, etc., but preferably is circular.

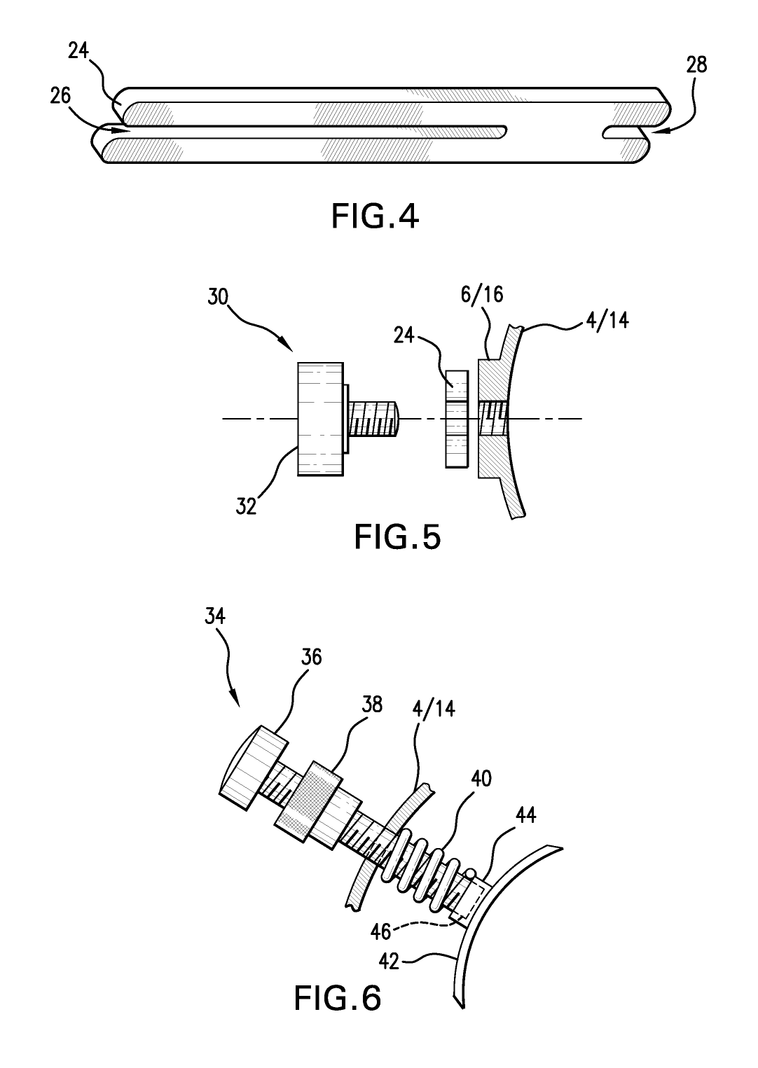

The camera ring 4 is interrelated with the scope ring 14 by means of a strut 24 as shown in FIG. 4. The strut has two apertures, a connector strut first aperture 26 and a connector strut second aperture 28. The apertures 26, 28 may be of any suitable length to achieve the purpose of the present invention, but preferably the first aperture (or long aperture) 26 is approximately two-thirds the length of the strut and the second aperture (or short aperture) 28 is approximately one-fourth the length of the strut 24.

The short aperture 28 is used preferably to interrelate the strut 24 with the scope ring 14. The long aperture 26 is used preferably to interrelate the strut 24 with the camera ring 4. The long aperture 26 enables a user to slide the camera ring along the length of the long aperture 26 to abut a lens of a camera 56 with an eyepiece of a scope 56. The short aperture 28 and the long aperture 26 may be used in reverse as well.

The strut 24 is interrelated to the camera ring 4 by means of a strut pin 30. With reference to FIG. 5, the strut pin 30 is threaded and screws into a strut pin through-hole 8 on the camera ring 4. As assembled, the long aperture 26 of the strut 24 is butted against a strut land 6 on the camera ring 4. The strut pin 30 is passed through the long aperture 26 and screwed into the strut through-hole 8 to secure the strut 24 to the camera ring 4. The strut pin 30 has a knurled strut knob 32 to assist a user in grasping and turning the strut pin 30.

In like manner, the strut 24 is attached to the scope ring 14 by means of a strut pin 30. With reference to FIG. 5, the strut pin 30 is threaded and screws into a strut pin through-hole 18 on the scope ring 14. As assembled, the short aperture 28 of the strut 24 is butted against a strut land 16 on the scope ring 4. The strut pin 30 is passed through the short aperture 28 and screwed into the strut through-hole 18 to secure the strut 24 to the scope ring 14. The strut pin 30 has a knurled strut knob 32 to assist a user in grasping and turning the strut pin 30. As noted previously, the short aperture 28 and the long aperture 26 may be used in reverse as well.

With reference to FIG. 1, FIG. 9 and FIG. 10, a camera 54 is secured within the camera ring 4 by means of a cup 48. Preferably, the cup 48 is a suction cup that can easily grip the camera 54 regardless of shape. The cup 48, however, may be of any suitable material capable of abutting and securing a camera of any type within the camera ring 4.

With reference to FIG. 6, a locking pin 34 is shown. The locking pin is threaded and is inserted into a locking pin through-hole 20 in the scope ring 14. Through-hole 20 is not threaded to allow for free passage and movement of the locking pin 34 therein. After passing through the locking pin through-hole 20, a spring 40 is placed around the locking pin 34 and the locking pin 34 screws into a bracket hole 46 within a bracket land 44 of the bracket 42. The spring 40 is used to achieve tension and grip in order to grip the bracket 42 against the scope 56.

In the mounting apparatus 2 of the present invention there are at least two locking pins 34 used to secure the scope 56 within the scope ring 14, and preferably three locking pins 34 are used to secure the scope 56 within the scope ring 14. As shown in FIG. 3B, there are three locking pin through-holes 20 spaced equidistantly around the scope ring 14. The three locking pins 34 are inserted through the scope ring 14 and into the brackets 42 and then the brackets 42 are butted up against the scope 56.

A nut 38 of each locking pin 34 is used to retract the locking pin 34 by screwing the nut 38 down to the scope ring 14 and continuing to screw the nut 38 down until a desired amount of retraction is achieved. This allows for a barrel of the scope 56 to be easily slipped onto the scope ring 14. By screwing the nut 38 back to the head of the locking pin 34, the locking pin 34 is forced against the scope 56 by the tension of the spring 40 and which allows the bracket 42 to achieve a firm grip on the scope 56. The nut 38 and the locking pin 34 are preferably knurled to enable a user to grip and turn easily the nut 38 while grasping the locking pin 34.

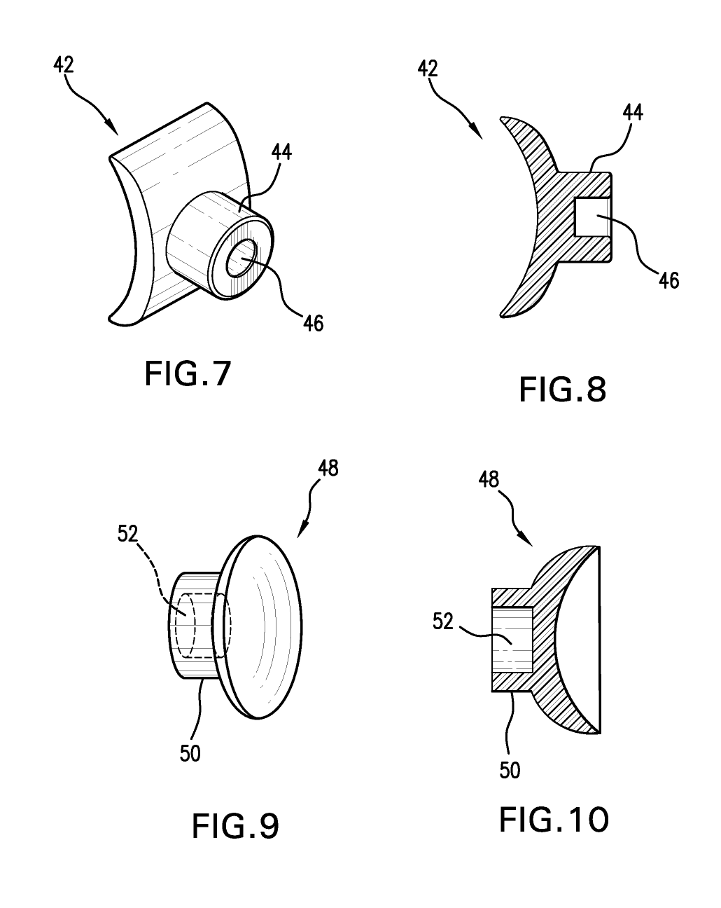

With reference to FIG. 1, FIG. 7 and FIG. 8, a scope 56 is secured within the scope ring 14 by means of a bracket 42. Preferably, the bracket 42 is a rigid bracket that can butt against a barrel of the scope 56. The bracket 42, however, may be of any suitable material capable of abutting and securing a scope of any type within the scope ring 14.

Also with reference to FIG. 6, use of the locking pin 34 to secure the camera 54 within the camera ring 4 can be understood; wherein a cup 48 is substituted for the bracket 42. The locking pin is threaded and is inserted into a locking pin through-hole 10 in the camera ring 4. The through-hole 10 is not threaded in order to allow for free passage and movement of the locking pin 34 therein. After passing through the locking pin through-hole 10, a spring 40 is placed around the locking pin 34 and the locking pin 34 screws into a cup hole 52 within a cup land 50 of the cup 48. Spring 40 is used to achieve tension in order to grip the cup 48 against the camera 54.

In the mounting apparatus 2 of the present invention there are at least two locking pins 34 used to secure the camera 54 within the camera ring 4, and preferably three locking pins 34 are used to secure the camera 54 within the camera ring 4. As shown in FIG. 3A, there are three locking pin through-holes 10 spaced equidistantly around the camera ring 4. The three locking pins 34 are inserted through the camera ring 4 and into the cups 48 and then the cups 48 are butted up against the camera 54.

A nut 38 of each locking pin 34 is used to retract the locking pin 34 by screwing the nut 38 down to the camera ring 4 and continuing to screw the nut 38 down until a desired amount of retraction is achieved. This allows for the camera 54 to be easily slipped into the camera ring 4. By screwing the nut 38 back to the head of the locking pin 34, the locking pin 34 is forced against the camera 54 by the tension of spring 40 which allows cup 48 to achieve a firm grip on the camera 54. The nut 38 and locking pin 34 are preferably knurled to enable a user to grip and turn easily the nut 38 while grasping the locking pin 34.

With reference to FIG. 3A, camera ring 4 has accessory pin through-holes 12 therein. There are at least two and preferably three accessory pin through-holes 12. The accessory pin through-holes 12 are threaded. The locking pins 34, or any other suitable attachment means, such as screws, bolts, pins and the like, may be used in conjunction with the accessory pin through-holes 12 to secure an accessory to the camera ring 4. Such an accessory may be a cover to protect the camera 54 from the elements if the mounting apparatus 2 of the present invention is used outdoors. The accessory may be a tripod to allow the camera ring 4 to be used without the scope ring 14.

With reference to FIG. 3B, scope ring 14 has accessory pin through-holes 22 therein. There are at least two and preferably three accessory pin through-holes 22. The accessory pin through-holes 22 are threaded. The locking pins 34, or any other suitable attachment means, such as screws, bolts, pins and the like, may be used in conjunction with the accessory pin through-holes 22 to secure an accessory to the scope ring 14. Such an accessory may be a cover to protect the scope 56 from the elements if the mounting apparatus 2 of the present invention is used outdoors.

Once a camera 54 is secured within a camera ring 4 and a scope 56 is secured within a scope ring 14, then the strut pin 32 of the camera ring 4 may be loosened slightly to allow the camera ring 4 to be slid along the length of aperture 26 (or aperture 28, as applicable) until the lens of the camera 54 is butted up against the eyepiece of the scope 56. The strut pin 32 is then tightened to secure and hold the camera ring 4 in place relative to the scope ring 14.

The camera ring 4, scope ring 14, strut 24 and bracket 42 of the mounting apparatus 2 of the present invention may be made of any suitable material, such as plastic or metal. The camera ring 4 and the scope ring 14 are preferably made of plastic and are interchangeable. The strut 26 and the bracket 42 of the mounting apparatus 2 of the present invention also are preferably made of plastic. The use of a plastic material to make the camera ring 4, scope ring 14, strut 24 and bracket 42 of the mounting apparatus 2 of the present invention allows for each of these parts to be made by an injection molding process which is efficient, creates uniform and durable parts and is cost effective.

The locking pin 34 may be used in different configurations beyond the standard configuration shown in FIG. 6. The nut 38 may be placed between the bracket 42 or cup 48 allowing for increased tension of the spring 40. This can be useful when using a narrow camera or scope. Alternatively, the spring 40 can be removed, the nut 38 can be placed between the bracket 42 or the cup 48 and used to lock the locking pin 34 against a camera, scope or other object, such as a mounting post, by screwing the nut 38 against either the camera ring 4 or the scope ring 14. Finally, the nut 38 and the spring 40 can be removed and the locking pin 34 can be screwed into the accessory through-holes 12, 22 using the threads in accessory through-holes 12, 22 to lock the pin 34 against the camera 54, the scope 56, or another object.

In an alternative embodiment of the mounting apparatus 2 of the present invention, the cups 48 of the camera ring 4 and the brackets 42 of the scope ring 14 may be removed and substituted with a circular clamping means. The clamping means may be rigid, such as a hose clamp, or may be a resilient, elastic material, such as an O-ring, gasket, membrane, circular band or other suitable resilient, elastic material able to dynamically retain a device. The clamping means may be suitably modified to be attachable to the locking pins 34 or directly attachable to the camera ring 4 or the scope ring 14. When using the clamping means, the camera 54 or the scope 56 is inserted into the center of the clamping means and the clamping means is adjusted around the device to retain it therein.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are described.

Although the present invention has been described with reference to specific embodiments, it is understood that modifications and variations of the present invention are possible without departing from the scope of the invention, which is defined by the claims set forth below.

The invention claimed is:

1. An apparatus for mounting a camera to another optical instrument comprising:
a. At least two mounting rings, interrelated by means of
b. At least one strut;
wherein each mounting ring further comprises at least two equidistantly spaced locking pins to mount either a camera or an optical instrument within the mounting ring.

2. The apparatus of claim 1, further wherein the strut interrelates with each mounting ring by means of a strut pin.

3. The apparatus of claim 1, further wherein the strut slidably interrelates with at least one mounting ring to permit relational positioning of the mounting rings to each other.

4. The apparatus of claim 1, further wherein the locking pins have a bracket attached thereto to secure the optical instrument within one of the mounting rings.

5. The apparatus of claim 1, further wherein the locking pins have a cup attached thereto to secure the camera within one of the mounting rings.

6. The apparatus of claim 1, further wherein each mounting ring further comprises at least two equidistantly spaced accessory pin through-holes.

7. An apparatus for mounting a camera to another optical instrument comprising:
a. a camera mounting ring for mounting a camera therein;
b. a scope mounting ring for mounting an optical instrument therein;
c. at least one strut that interrelates the camera mounting ring with the scope mounting ring;
d. at least two equidistantly spaced locking pins within the camera mounting ring to mount the camera therein; and
e. at least two equidistantly spaced locking pins within the scope mounting ring to mount the optical instrument therein.

8. The apparatus of claim 7, further wherein the strut interrelates with each mounting ring by means of a strut pin.

9. The apparatus of claim 7, further wherein the strut slidably interrelates with at least one mounting ring to permit relational positioning of the mounting rings to each other.

10. The apparatus of claim 7, further wherein the locking pins have a bracket attached thereto to secure the optical instrument within the scope mounting ring.

11. The apparatus of claim 7, further wherein the locking pins have a cup attached thereto to secure the camera within the camera mounting ring.

12. The apparatus of claim 7, further wherein each mounting ring further comprises at least two equidistantly spaced accessory pin through-holes.

13. An apparatus for mounting a camera to another optical instrument comprising:
a. At least two mounting rings, interrelated by means of
b. At least one strut;
wherein each mounting ring further comprises a clamping means to mount either a camera or an optical instrument within the mounting ring.

14. The apparatus of claim 13, further wherein the strut interrelates with each mounting ring by means of a strut pin.

15. The apparatus of claim 13, further wherein the strut slidably interrelates with at least one mounting ring to permit relational positioning of the mounting rings to each other.

16. The apparatus of claim 13, further wherein each mounting ring further comprises at least two equidistantly spaced accessory pin through-holes.
